(19) United States
(12) Patent Application Publication
(10) Pub. No.: US 2002/0047248 A1
(43) Pub. Date: Apr. 25, 2002

(54) Vehicle/implement coupling device

(76) Inventors: Gerd Bernhardt, Hanichen (DE); Sergiy Fedotov, Dresden (DE); Ruslan Rudik, Dresden (DE); Heinz Weiss, Bensheim (DE)

Correspondence Address: Deere & Company, John Deere Road, Moline, IL, 61265-8098, US

(21) Appl. No.: 09/972,611

(22) Filed: Oct. 5, 2001

(30) Foreign Application Priority Data
Oct. 20, 2000 (DE) 100 52 051.0

(51) Int. Cl. B60D 1/01; B60D 1/14; B60D 1/167; B60D 1/173

(52) U.S. Cl. 280/504

(57) ABSTRACT

A coupling device couples a vehicle, such as an agricultural or industrial vehicle, to an implement, such as trailer. The device includes a three-point implement interface with a coupling frame which is movably mounted on a chassis of the vehicle. A one-point coupling is mounted on the coupling frame. The coupling frame may be connected to the vehicle chassis by means of adjustable length connecting elements, which are preferably arranged in the form of a hexapod.

### BACKGROUND OF THE INVENTION

The present invention relates to a coupling device for coupling a vehicle, such as an agricultural or industrial vehicle, to an implement, trailer or the like, and more particularly, to such a device which includes an implement interface in the form of a three-point hitch with a coupling frame which is mounted on the vehicle and which can be moved relative to the vehicle chassis.

Such a known coupling device is described in Standard ISO 11001-2 and in DE-AS-1 215 419. Such known one-point couplings are typically rigidly mounted on the trailer coupling of a tractor, or adjustably mounted as shown in DE-A-31 22 116, DE-A-35 06 466, or EP-A-0 667 252. This has the disadvantage that the height of the one-point coupling is not always exactly adapted to the trailer or the towed implement. This means that the expenditure of labor and time is increased and that two persons may be required for carrying out the coupling process. In addition, an adjustment of the coupling height is laborious and usually requires the application of great force.

### SUMMARY

Accordingly, an object of this invention is to provide an adjustable height one-point coupling device.

A further object of the invention is to provide such a coupling device which can be height adjusted by a single operator, preferably from the driver's cabin.

These and other objects are achieved by the present invention, wherein a one-point coupling is mounted in a coupling frame of a three-point hexapod hitch for use in coupling towed implements, trailers or the like to a vehicle, such as an agricultural or industrial vehicle. A three-point hitch can be adjusted relative to the tractor and has an implement interface or coupling frame with a one-point coupling mounted thereon.

The term hitch refers to any coupling device that can be adjusted relative to the vehicle and forms a coupling surface, by means of which an implement can be coupled to the vehicle and adjusted with respect to its position. The coupling device does not necessarily have to contain singular coupling points that lie in one plane, and the coupling points do not necessarily have to be arranged in a triangular pattern.

The one-point coupling is integrated into the coupling frame of the implement interface of the three-point hitch, with the one-point coupling being variably adjustable with respect to its height and, if applicable, laterally and in the longitudinal direction of the vehicle. This makes it possible to adjust the coupling to different draw-bar heights of trailers and to different spatial positions of the coupling elements of implements. The coupling of a trailer or implement may, depending on the respective design, take place in the form of a one-dimensional, two-dimensional or three-dimensional movement of the coupling frame, namely without moving the vehicle or the implement. The coupling operation can be performed by one person from the operating platform.

The coupling frame preferably forms a triangle with two lower corners and an upper corner. The coupling frame is connected to the vehicle chassis by connecting elements which are attached near the corners. Preferably, at least one of the connecting element is adjustable in length. The coupling frame may include three limbs which form a triangular frame. Alternatively, the coupling frame may include only two limbs which are connected to each other in the shape of an upside-down V and which diverge downwardly, and which from an opening with sufficient space for a power take-off shaft. Alternatively, the frame could have a U-shape instead of the above-mentioned V-shape.

The frame may have a design based on the so-called A-frame coupling defined in International Standard ISO 11001-2. The A-frame coupling is connected to the vehicle chassis in an articulated fashion by means of two lower connecting rods and an upper connecting rod, into which an adjustable length hydraulic cylinder is integrated. If so required, the lower connecting rods may also contain adjustable length hydraulic cylinders.

Preferably, the one-point coupling is mounted on a carrier which is attached to the two limbs of the frame near the intersection of the limbs. Preferably, the one-point coupling does not lie in the coupling plane of the three-point hitch, but rather is offset toward the vehicle chassis from the plane of the coupling frame. With respect to a triangular coupling frame, the one-point coupling is preferably arranged in a central region of the triangle. This provides sufficient space for allowing an unobstructed manipulation of the three-point hitch.

The coupling frame is preferably connected to the vehicle chassis by means of a least six adjustable length connecting elements which are arranged in closed kinematic chains and allow the movement of the coupling frame in six degrees of freedom. Preferably, the connecting elements form a hexapod, such as described in published patent DE-AS-199 51 840.

The adjustable length connecting elements may be hydraulically or electrically driven elements. Preferably, the connecting element is a hydraulic cylinder which can produce a relatively large stroke within a short period of time with a relatively high force. Such hydraulic cylinders may also serve as shock absorbers for the one-point coupling and may absorb vibrations transmitted by a draw-bar.

Three-point mounting catch hooks for coupling to an implement are preferably arranged on the coupling frame. For example, three catch hooks may be mounted on the corner points of a triangular coupling frame. However, the coupling frame may also be similar to a rapid-action coupling that can be easily coupled to a corresponding triangular frame of the implement, such as in a coupling device which consists of two triangular frames, as described in DE-AS 1 215 419.

The one-point coupling preferably consists of a towing device, in particular, a receiver, such as described in Standard 79/533/EWG or DIN 74 956. A ball coupling or another coupling implement may also be considered for the one-point coupling.

The one-point coupling may also comprise an automatic trailer coupling which automatically moves a securing bolt through corresponding openings when the draw-bar of a trailer is inserted into the one-point coupling and thusly automatically couples the trailer to the vehicle. Such an automatic trailer coupling is disclosed in DE-AS-1 095 132.

### BRIEF DESCRIPTION OF THE DRAWINGS

FIG. 1 is a perspective view of a coupling device according to the invention attached to the rear of a tractor;

FIG. 2 is a side view of a trailer coupled to a tractor by the coupling device of the invention; and

FIGS. 3 and 4 are side views of the coupling device of FIG. 1 in two different coupling heights.

### DETAILED DESCRIPTION

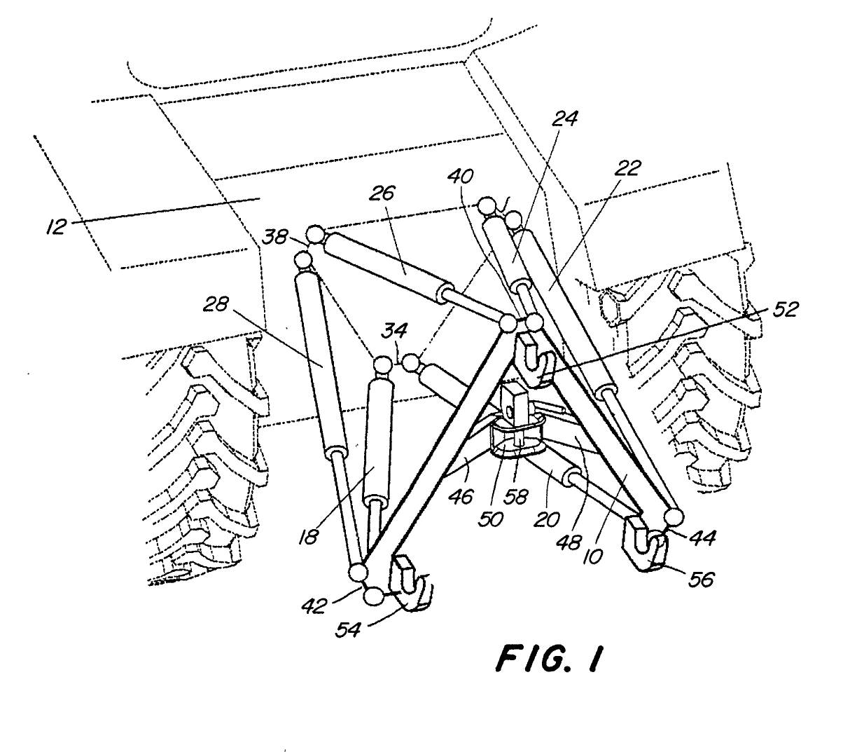

An implement interface is shown in FIG. 1 and includes a triangular coupling frame 10 and six adjustable length connecting elements 18, 20, 22, 24, 26, 28. One end of each connecting elements is respectively connected in an articulated fashion to the vehicle chassis 12, e.g., the differential housing or the vehicle frame, with the other end being connected in an articulated fashion to the coupling frame 10.

The connecting elements 18, 20, 22, 24, 26, 28 are coupled to the vehicle at points which lie at corner points 34, 36, 38 of a triangle on the side of the vehicle. The lower corner point 34 is centered with respect to the lateral dimension of the vehicle. The upper corner points 36, 38 lie above the lower corner point 34 at the same elevation, and are arranged symmetrical in the lateral direction of the vehicle.

The connecting elements 18, 20, 22, 24, 26, 28 are coupled to the frame 10 at corner points 40, 42, 44 of a triangle formed by the frame 10. Corner point 40 is higher than lower corner points 42, 44. Lower corner points 42, 44 have the same elevation and are arranged underneath the upper corner point 40. The connecting elements 18, 20, 22, 24, 26, 28 are arranged in the form of a hexapod. These connecting elements are preferably double-action hydraulic cylinders, but electromechanical adjusting elements may, in principle, also be considered for this purpose.

The coupling frame 10 includes two limbs that are connected to one another on the top and diverge transversely downward. On the side that faces away from the vehicle, the coupling frame 10 carries an upwardly open hook 52, 54, 56 at each corner points 40, 42, 44. The hooks provide a rigid three-point coupling for work implements.

Carriers 46, 48 are mounted in the central region of each limb of the coupling frame 10. The carriers 46, 48 converge and are joined together. A one-point coupler or receiver 50, such as a receiver-type towing device, is mounted at the intersecting point of these carriers. This towing device consists of an automatic trailer coupling in which the bolt 58 automatically moves into corresponding openings as soon as the draw-bar is moved into the receiver.

The carriers 46, 48 do not lie in the coupling plane defined by the coupling frame 10, but rather project towards the vehicle chassis 12 and away from the coupling frame 10, so that the one-point coupler 50 is offset relative to the coupling plane towards the chassis 12. The one-point coupler 50 approximately lies in the center between the corner points 42, 44, 46 of the coupling frame 10. Due to this arrangement, the mechanical catch hooks 52, 54, 56 of the three-point coupling are arranged at different locations than the receiver of the one-point coupler 50 such that these components do not impair one another.

FIG. 1 shows the six hydraulic cylinders 18, 20, 22, 24, 26, 28 in a partially extended state in which the full mobility of the three-point coupling and consequently the one-point coupling is realized.

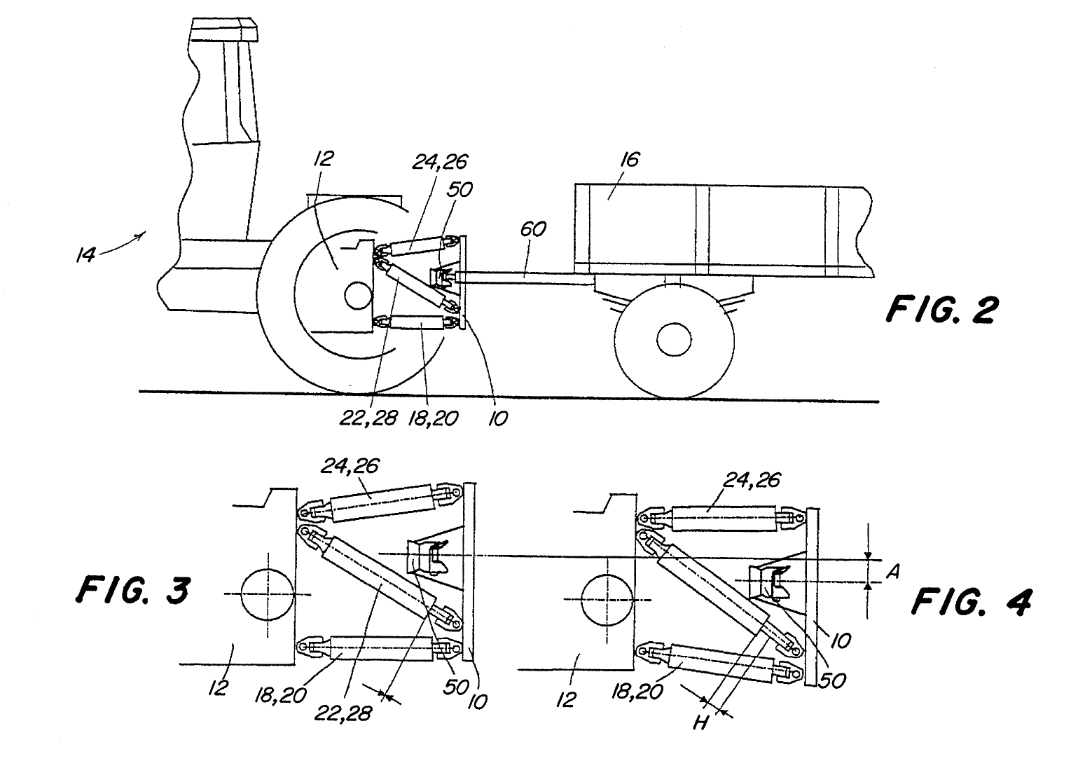

Referring now to FIG. 2, the coupling device is coupled between a rear part of a tractor 14 and a front part of a trailer 16. The openings on the front end of the draw-bar 60 of the trailer 16 are situated in the receiver 50 of the coupling device and fixed therein by means of a securing bolt 58. This position represents the transport position.

The actuation of the connecting elements 18, 20, 22, 24, 26, 28 makes it possible to adjust their length. Consequently, the coupling frame 10 is able to variably move in six degrees of freedom within a broad range. This makes it possible to locate the element to be coupled, such as a draw-bar, during the coupling process, while the vehicle is at a standstill. In this case, the connecting elements 18, 20, 22, 24, 26, 28 and consequently the coupling frame 10 are suitably extended until the draw-bar is received in the receiver 50. In this case, the one-point coupling is locked under pressure. Subsequently, the connecting elements 18, 20, 22, 24, 26, 28 are fully retracted so that a rigid coupling arrangement is realized.

The work position of the receiver 50 can be adjusted within a broad range by retracting and extending the connecting elements 18, 20, 22, 24, 26, 28. FIGS. 3 and 4 show that, for example, the one-point coupler 50 can be adjusted to different draw-bar heights of the trailer 16 by retracting and extending the hydraulic cylinders 22 and 28. In FIGS. 3 and 4, the hydraulic cylinders 18, 20, 24 and 26 are fully retracted while the hydraulic cylinders 22 and 28 are partially extended. The stroke H of the cylinders 22 and 28 is greater in FIG. 4 than in FIG. 3 so that the coupling height in FIG. 4 is lower than in FIG. 3 by the amount A. The adjustment of the connecting elements 18, 20, 22, 24, 26, 28 may be controlled by a suitable control unit (not shown) from the driver's cabin.

Although the invention was merely described with reference to one embodiment, a person skilled in the art is able to ascertain from the previous description and the figures that the scope of the invention includes various alternatives, modifications and variations. For example, the coupling frame may be connected to the vehicle chassis by means of two lower connecting rods and one upper connecting rod of adjustable length instead of the described hexapod arrangement. In addition, the catch hook may be replaced with a coupling frame that is designed in the form of a rapid-action coupling in which a frame arranged on the side of the implement can be secured.

We claim:

1. A coupling device for coupling an implement to a vehicle, the coupling device comprising:
a coupler frame having a three-point implement interface, the frame being movably coupled to a chassis of the vehicle; and
a one-point coupler mounted on the coupling frame.

2. The coupling device of claim 1, wherein:
the coupling frame has a triangular shape with two lower corners and one upper corner; and
the coupling frame is coupled to the vehicle chassis by a plurality of connecting elements, the connecting elements being connected to the vehicle chassis at points which are near to corners of a triangle, and at least one of the connecting elements is adjustable in length.

3. The coupling device of claim 1, wherein:
the coupling frame has a shape similar to an upside-down V or U.

4. The coupling device of claims 1, wherein:
the coupling frame comprises a pair of limbs which converge towards an intersection; and
a carrier is mounted on the limbs, and the one-point coupler is mounted on the carrier.

5. The coupling device of claim 1, wherein:
the one-point coupling is positioned between the frame and the vehicle chassis.

6. The coupling device of claims 1, wherein:
the coupling frame has a triangular shape; and
the one-point coupling is positioned in a central portion of the coupler frame.

7. The coupling device of claim 1, wherein:
that the coupling frame is connected to the vehicle chassis by at least six adjustable length connecting elements, said connecting elements being arranged in closed kinematic chains so that the coupling frame is movable with six degrees of freedom.

8. The coupling device of claim 7, wherein:
the connecting elements are arranged in the form of a hexapod.

9. The coupling device of claim 2, wherein:
at least one of the connecting elements includes an adjustable length hydraulic cylinder.

10. The coupling device of claim 1, wherein:
catch hooks mounted on the coupling frame, said catch hooks forming a three-point coupling for attaching to an implement.

11. The coupling device of claim 1, wherein:
the one-point coupling comprises a receiver towing device.

12. The coupling device of claim 1, wherein:
the one-point coupling comprises an automatic trailer coupling.
